(19) United States
(12) Patent Application Publication
(10) Pub. No.: US 2016/0267484 A1
(43) Pub. Date: Sep. 15, 2016

(54) MEDICAL DATA COLLECTION AND FRAUD PREDICTION SYSTEM AND METHOD

(71) Applicant: MEDICFP LLC, Hollywood, FL (US)

(72) Inventors: ROBERT SMOLEY, AVENTURA, FL (US); ALLAN VOSS, BONITA SPRINGS, FL (US); ROMAN JURKOV, DELRAY BEACH, FL (US); STEPHEN CARLSON, FOLSOM, CA (US); TOMAS TEZAK, BOCA RATON, FL (US)

(21) Appl. No.: 15/165,739

(22) Filed: May 26, 2016

Related U.S. Application Data
(63) Continuation-in-part of application No. 14/668,307, filed on Mar. 25, 2015.
(60) Provisional application No. 61/970,041, filed on Mar. 25, 2014.

(51) Int. Cl. G06Q 20/40; G06F 19/00

(52) U.S. Cl. CPC G06Q 20/4016; G06F 19/328; G06Q 20/40145

(57) ABSTRACT

A goods, services and payment authorization system and method are provided to prevent services from being rendered, goods from being provided and/or reimbursements from being made in the case of fraudulent healthcare transactions resulting from identity theft, phantom billing, lack of insurance coverage and/or medical fraud, in general. In conjunction with a healthcare transaction, patient identity information is collected and insurance coverage is confirmed using a programmatic calculation of a confidence determination based on the collected identity information.

### CROSS-REFERENCE TO RELATED APPLICATIONS

The present application is a continuation-in-part of co-pending U.S. patent application Ser. No. 14/668,307, filed on Mar. 25, 2015, which claimed priority from Provisional Patent Application No. 61/970,041, filed on Mar. 25, 2014; those applications being incorporated herein, by reference, in their entireties.

### BACKGROUND OF THE INVENTION

1. Field of the Invention

The invention relates to a medical data collection system and method and, more particularly, to a HIPAA compliant medical data collection system and method utilizing a determination method to verify the integrity of a user's identity and authorize goods and/or services.

2. Description of the Related Art

Healthcare fraud costs the health insurance/Medicare/Medicaid industry billions of dollars every year. Healthcare fraud can occur as the result of, on the Provider side, phantom billing, padded billing, double billing, upcoding, unbundling, and outright theft of Provider identities, among others. On the Patient side, healthcare fraud can take the form of prescription fraud, identity theft, forum shopping (Provider and pharmacy), and substance abuse/dealing. Such fraud can be hard to identify prior to the payout of a claim by the health insurance/Medicare/Medicaid industry.

A number of references are known that have been directed to preventing healthcare fraud by authenticating that a user is who they say they are. For example, U.S. Pat. No. 7,421,399 to Kimmel discloses a system and method for implementing healthcare fraud countermeasures in which the patient provides a biometric signature to create a persistent record indicating that a particular person was physically present at a particular place. Similarly, U.S. Pat. No. 8,583,454 to Beraja et al., discloses a medical claims fraud prevention system in which a patient identity may be verified by performing a comparison of a patient with the official photograph of the patient. These references attempt to provide a patient authentication by validating that a user is who they say they are via a physical characteristic of the patient and/or by tying this physical characteristic to a data record or code.

However, what is needed is an authorization system that validates that a user is entitled to a particular service or set of services via a determination process that verifies the integrity of the user's identity.

### BRIEF SUMMARY OF THE INVENTION

It is accordingly an object of the invention to provide a medical data collection system that validates that a user is entitled to a particular service or set of services via a determination process that verifies the integrity of the user's identity. In one particular embodiment of the invention, the system analyzes both real-time and historical data to assess the legitimacy of a healthcare transaction before allowing access, rendering services and/or processing payment.

More particularly, in one embodiment of the invention the system operates as a goods, services and payment authorization system, to prevent services from being rendered, goods from being provided and/or reimbursements from being made in the case of fraudulent healthcare transactions resulting from identity theft, phantom billing, medical fraud and lack of insurance coverage, in general. More particularly, in one particular embodiment of the invention, in conjunction with a healthcare transaction, patient identity information is collected and insurance coverage is confirmed using a programmatic calculation of a confidence determination based on the collected identity information.

Although the invention is illustrated and described herein as a medical data collection and fraud prediction system and method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

For the purpose of illustrating the invention, there is shown in the drawings an exemplary embodiment that is presently preferred, it being understood however, that the invention is not limited to the specific methods and instrumentalities disclosed. Additionally, like reference numerals represent like items throughout the drawings. In the drawings:

FIG. 1 is an exemplary diagram illustrating one particular embodiment of the invention;

FIG. 2 is a simplified block diagram of a portion of the system in accordance with one particular embodiment of the invention;

FIGS. 3A and 3B are an exemplary illustration of the front and back, respectively, of an official government-issued ID card, useful in a process in accordance with one particular embodiment of the invention;

FIG. 4 is a flow chart illustrating the scoring and determination processes performed in accordance with one particular embodiment of the invention;

FIG. 5 is a flow chart illustrating method of performing a data point scoring process in accordance with one particular embodiment of the present invention;

FIG. 6 is an exemplary table illustrating a confidence level determination for a particular dataset in accordance with one embodiment of the present invention;

FIG. 7 is an exemplary table illustrating a confidence level determination for particular data points in accordance with one embodiment of the present invention;

FIG. 8 is an exemplary table illustrating an importance multiplier determination for particular data points in accordance with one embodiment of the present invention;

FIG. 9 is an exemplary authorization process used to illustrate one particular embodiment of the present invention; and

FIG. 10 is an exemplary authorization process used to illustrate a particular embodiment of the present invention.

### DETAILED DESCRIPTION OF THE INVENTION

The data collection system of the present invention flags various forms of fraud by analyzing both real-time and historical data. In one particular embodiment, the invention utilizes a determination algorithm to identify a likelihood of fraud and to make a recommendation regarding authorization. The invention can, thus, identify fraud and provide that information to insurance companies and/or government in real-time. In one particular embodiment of the invention, a determination report is generated so that a provider can address the fraud before any treatment is provided and/or a payer can make a determination before any disbursements are made. The system and method can be used in addition to, or as an alternative to, all or parts of the systems and methods disclosed in co-pending U.S. patent application Ser. No. 14/668,307, assigned to the present assignee and published as U.S. Patent Application Publication No. 2015/0278462, that application incorporated by reference, herein, in its entirety.

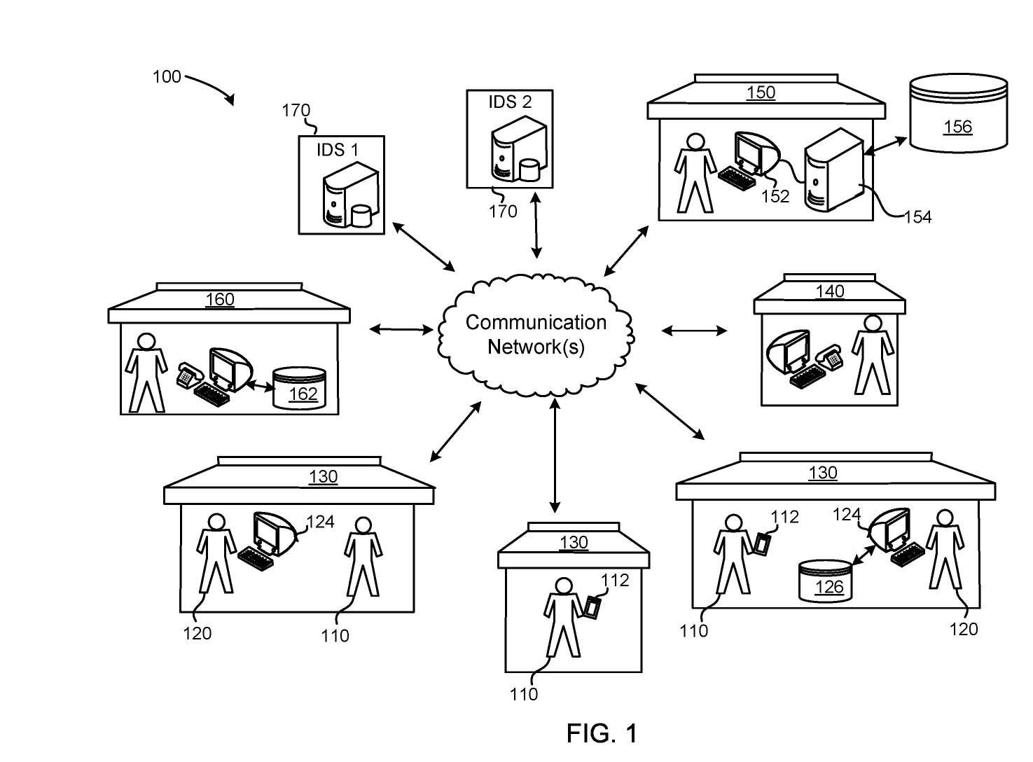

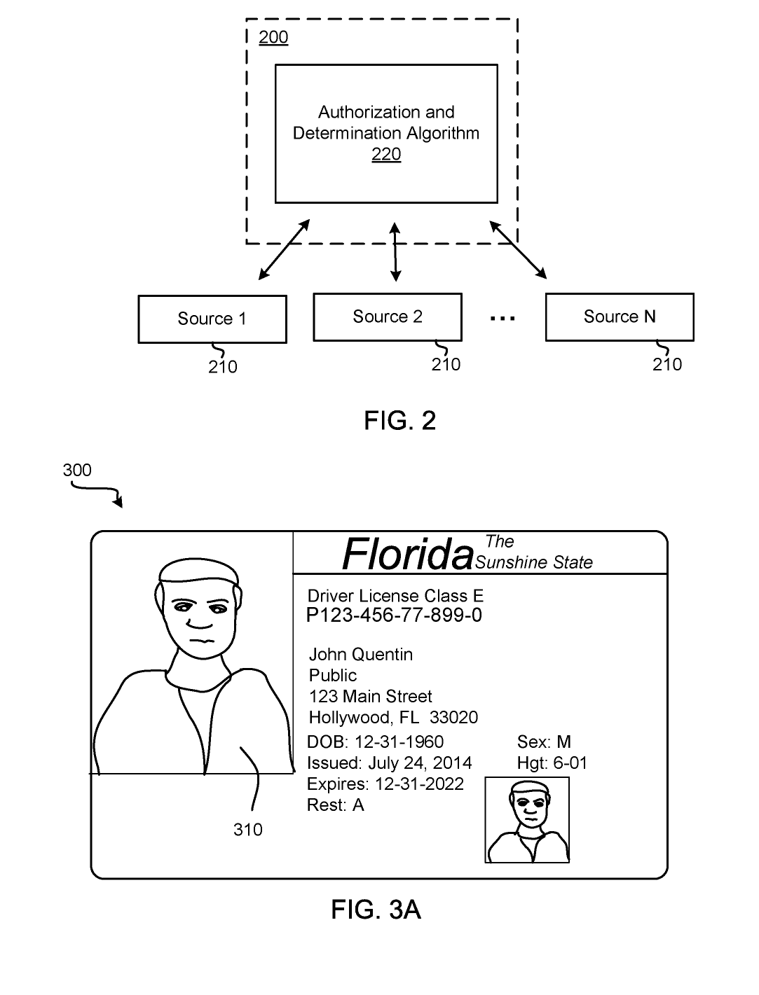

Referring now to FIGS. 1 and 2, an exemplary system 100 useful in will now be described in accordance with one particular embodiment of the invention. For purposes of the present embodiment, the following definitions will be used:

Authentication: A process that validates that a user is who they say they are.

Authorization: A process that validates that a user 110 is entitled to a particular service or set of services.

Dataset: a group of data point values with a common origin.

Customer, Patient or User (used interchangeably herein): The customer, patient or user 110 is the entity that requests access to the system 100 or a service. The responsibilities of the user 110 include: registering into the system 100 by providing the requested forms of ID and biometrics; and becoming authenticated before receiving or requesting service or access. The user responsibilities can be performed by the user 110, either as a self-conducted process or with the help of a system operator 120.

Operator or System Operator: When applicable, a system operator 120 may assist the user 110 in interactions with the system 100. At times, the operator 120 may make decisions to help the process move forward. Tasks of the system operator 120 include, but are not limited to: interacting with the system's devices and software; validating one's self as the operator 120; collecting user information requested by the system; and following instructions to pass collected information on to the system.

Provider: The provider 130 is responsible for reviewing the determination information provided by the system in order to make decisions granting or denying a user's request for healthcare services, access or goods. When applicable, the role of the provider 130 can include interacting with the user 110 after authorization and validation to actually provide service. Other tasks of the provider 130 include, but are not limited to: reviewing system determinations after authorization and deciding whether or not to provide healthcare services, access and/or goods (including, but not limited to durable medical equipment); communicating to the user 110 the final decision on whether or not the user 110 will be authorized to receive the services, access and/or goods; and interacting with the user 110 to render service, access and/or goods, if applicable. Note that, in some scenarios, the operator 120 and provider 130 roles may be performed by the same person, as desired. Additionally, in certain mobile implementations of the present embodiment, the operator 120 may be absent from the system. Further, in some embodiments of the present invention utilizing mobile authorization, communication of the authorization determination may be implemented electronically, i.e., without direct interaction between the provider 130 and user 110.

Support Representative: A support representative 140 is responsible for interacting with the user 110 in cases where the system 100 is unable to electronically verify the identity of the user 110 independently, with or without the help of an operator 120. The support representative 140's tasks include, but are not limited to: comparing images provided by the authorization and validation processes to determine a match; and reviewing multiple pieces of user information to determine an outcome.

System Administrator: The system administrator 150 takes care of configuring and/or managing the system 100. Responsibilities of the system administrator 150 include, but are not limited to: creating user accounts for operators 120 and other staff, and managing their access levels; and maintaining an updated list of the installed provider systems 130.

Payer: To the extent that the user 110 does not self-pay for goods and/or services, a payer 160 is the person or organization ultimately responsible for reimbursing the cost of goods and/or services rendered by the provider 130. The Payer 160's tasks include, but are not limited to: authorizing or denying payment for services and/or goods, based on determination reports (to be discussed more particularly below); and reviewing and overriding determinations made in the determination reports, when appropriate.

In the present embodiment, the system 100 includes a number of electronic and software components 200 that can be used cooperatively to generate, in an automated fashion, a determination report regarding whether a user 110 is authorized for healthcare services and/or goods available from a provider 130. In order to operate, the system 200 utilizes particular software stored on a non-transitory computer-readable medium and executed by processors of computers and/or other types of computing devices in the system. Such computing systems and devices can be networked with one another by one or more wired or wireless communications networks, including, but not limited to, a LAN, a WAN and/or the Internet, to provide information between the system components. The computing and/or software modules implemented by the present embodiment of the system 200 may include, but are not limited to: a self-authorization mobile application; an authorization application; an administration console application; reporting modules and APIs; a presence manager; and an insurance eligibility system.

The Self-Authorization Mobile Application: In one particular embodiment of the invention illustrated in FIG. 1, the system 100 includes the ability for a user 110 to perform self authorization using a mobile device 112 of the user 110. In this case, the user 110 has downloaded a self-authorization mobile software application that resides in memory of, and is executable by a processor of, the mobile device 112. The self-authorization mobile application operates to establish the user 110′s identity before registration without the assistance of an operator 120 affiliated with the provider 130. The self-authorization mobile application receives inputs from the user 110 and will relay a determination of the likelihood of the user's eligibility for the goods and services requested to the provider 130 and/or operator 120.

The Assisted Authorization Application: As an alternative to self-authorization, assisted authorization application software can be stored in, and executable by a processor of, a mobile device, tablet, PDA, smartphone, laptop, personal computer and/or other computing device 124 of the provider 130 or can be accessible from the computing device 124 via a web-based browser form over the Internet or another communications network. In one particular embodiment of the invention, all data provided over the communications network is encrypted based on HIPAA requirements. The assisted authorization application software allows an operator 120 to conduct the authorization of the user 110, and to get immediate determination information regarding the authorizations of the user 110. The assisted authorization application makes use of peripherals and/or built in hardware components to capture and process information from the user 110 and to provide an authorization determination.

For example, for purposes of assisted authorization, in one embodiment, each provider 130 includes a computerized registration and electronic medical records system that can interface with the system 100. In one particular embodiment, the operator 120 or provider 130 accesses the system of the present invention via a computer 124 having an input device (such as a keyboard and/or mouse) and a display device. A provider login screen viewed at a computer of the provider 130 can assist with the check-in process of a user 110. In one embodiment, the software of the present embodiment is configured to provide an application “dashboard”, a type of visual/graphical, software-based control panel, accessible to the operator or staff member 120 or provider 130 after logging-in to the system. In one embodiment, from the dashboard, the provider may, among other things, view patient records, create new patient records (i.e., enter new patients 110 into the system) and receive indications relating to the authorization of treatment of a patient 110.

The Administration Console: As discussed above, the system 100 of the present embodiment utilizes a Service Administrator 150 to manage users and points of service (both physical and virtual). An administration console application (i.e,. software) can be executed by a computer 152 or server 154 and used by the Service Administrator 150 to perform these management tasks.

Reporting Modules and APIs: Along with the application programs that collect information and manage the interaction between the different actors 110, 120, 130, 140, 150 and the system 100 for authorization and validation purposes, the system 100 includes reporting applications that consolidate the data collected during all authorization requests and allows the data to be accessed, reviewed and analyzed. One or more databases 156 can be provided for this purpose. If desired, the data collected in the database(s) 156 can be made available via an API, so that it can be integrated with any external systems or processes.

The Presence Manager: The presence manager is the portion of the system that, in the present embodiment, is used at the point of service (typically, the location of the provider 130) to manage verified or authenticated users 110. It can provide a list of users waiting for services or goods. The presence manager allows both automated and direct communication between the provider staff and users 110. Additionally, it can generate a log containing the times and locations at which the user presented for, and/or received, goods and services.

The Insurance Eligibility System: The insurance eligibility system is a portion of the system that maintains information about the insurance eligibility of a pool of users 110, usually stored in one or more databases 162 of one or more payers 160. In one embodiment of the present invention, the validity of insurance coverage is verified based on the cross-referencing of the patient identity information collected from one or more sources (i.e., patient identity card, integrated data sources, etc.) with information stored in the insurance eligibility system and/or databases 162.

Referring again to FIGS. 1 and 2, the system 200 (i.e., the computing portion of the system 100) uses an authorization and determination algorithm 220 to analyze user data and determine a likelihood of user eligibility for goods and/or services. More particularly, the system 100 collects and processes values for particular data points from one or more sources 210 (preferably, from multiple sources) in order to provide an overall score that is used to determine whether the information provided by a user 110 is good enough to grant authorization for a transaction in the system 100. More particularly, the data point values collected by the system are compared, analyzed and weighted, in order to obtain the overall score of whether or not the information provided by the user 110 is sufficient for the system 100 to grant authorization for the transaction. Data point values can be collected from any and all types of identification cards and/or integrated data sources, among other sources.

The algorithm 220 is programmed to accept and accommodate an increasing number of sources 210, to improve accuracy of the authorization process. Among other things, in the present embodiment the algorithm 220 analyzes obtained values for particular data points and user information using a combination of Metaphone and Regex (“Regular Expression”) algorithm methodologies. Values associated with data points include, but are not limited to: 1) non-biometric information collected from the patient/user 110; 2) a scoring of the information collected from the patient, based on availability; 3) information collected from integrated data sources; 4) a scoring of information collected from Integrated data sources, based on its availability; 5) a validation by algorithmic matching of like data from all collection methods; 6) a scoring of the validation by algorithmic matching of like data from all collection methods, based on validation status; 7) a calculation and reporting of validation results based on all available scores; 8) a collection of biometrics based on validation results; 9) a scoring of collected biometrics based on availability; 10) a collection of biometric data from one or more biometric databases; 11) a scoring of the collected biometrics, based on availability; 12) a validation by algorithmic matching of biometric data from all collection methods; 13) a scoring of validation by algorithmic matching of biometric data from all collection methods; and/or 14) a final calculation and reporting of determination based on all valid results.

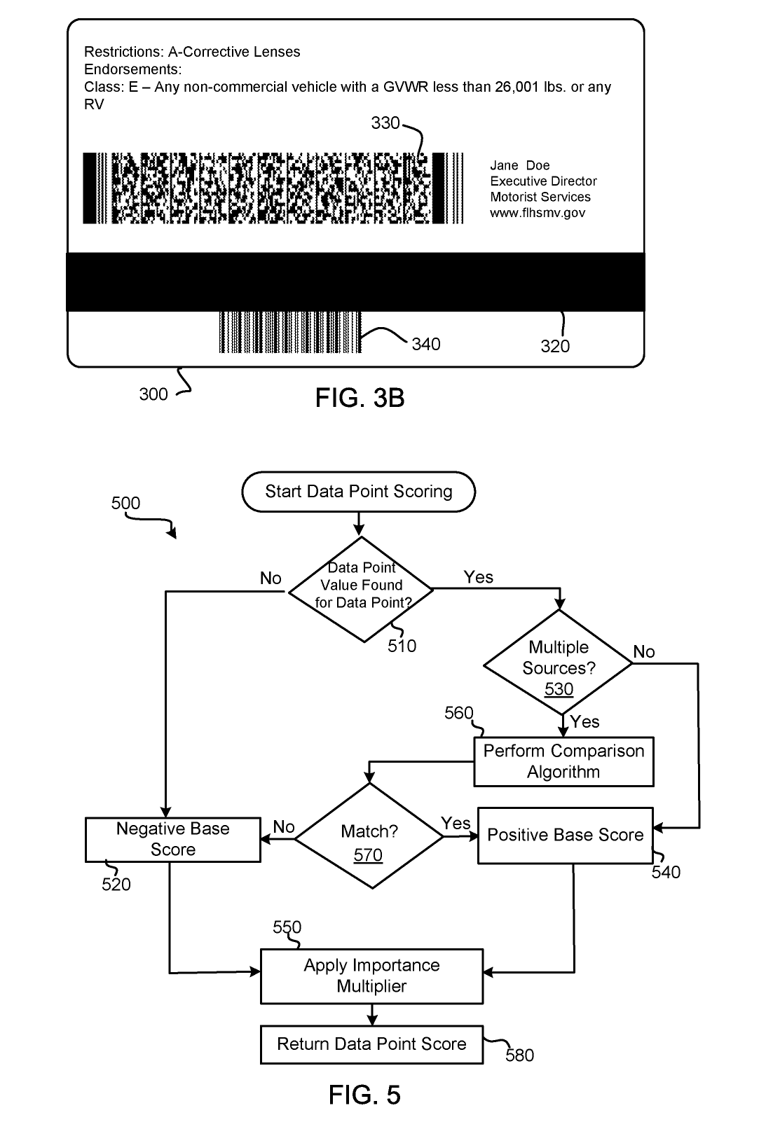

Information can be collected locally from the patient/user 110, via a computer or computing device 124 and/or mobile device 112. Among the information collected from the patient/user 110 can include, but is not limited to, information from a State ID, from an Insurance Card and/or from the front end interface/authorization software. For example, referring now to FIGS. 1, 3A and 3B, the user 110 can be asked to scan, photograph and/or enter data from a state or other official government-issued ID card 300, such as a drivers license, passport, identification card, concealed weapons permit, etc.. The system 200 can then mine data associated with, or depicted on, the ID card 300. For example, the following information, among other information, can be obtained from the government-issued ID card: given name; family name; middle name; photo; state; city; zip code; gender; date of birth—day; date of birth—month; date of birth—year; whether or not the user 110 is a minor; and/or the method of input of the data (i.e., electronic or manual entry). If available, different physical characteristics (i.e., height, weight, race, eye color), can also be obtained from the ID card. The reverse of the official government-issued ID card 300 can include other information, including an restrictions of the user, as well as electronically-readable encoded data. For example, the information on the ID card 300 can be encoded and written by an electronic device at the DMV onto a magnetic stripe 320 on the ID card 300. The information can additionally, or alternatively, be encoded into a high information density 2D barcode 330. Identifying information can also be provided in, or retrieved using, the information encoded in a linear barcode 340 printed on the reverse side of card 300.

Similarly, if an insurance card is used, the following information, among other information, can be obtained: Name of insured; Payer ID; Insurance ID; and/or input method.

Additionally, information can be obtained from the front end interface/authorization software executing on the user's mobile device 112 and/or the operator's computing device 124. the following information, among other information, can be obtained via the authorization software: the Facility ID; Facility Name; the Feed ID; the visit number; the Username; a checked-in status; and an identification of who checked the user in.

Further, information can collected from Integrated Data Sources (IDS) 170. More particularly, the system 200 can collect information from databases to which it has access. This includes electronic healthcare record databases, state and local databases (i.e., DMV, county property assessor database, etc.), insurance payer databases, etc. For example, a number of different types of electronic medical record (EMR) systems can be supported by the present invention. Any number of providers 130 may be using each of the different types of electronic medical records (EMRs), via different EMR system interfaces 124. In one particular embodiment of the invention, each one of these EMR systems can be used as an integrated data source 170—i.e., a source of patient identity data stored in a provider database 126 accessible by the system. Similarly, a payment database 162 of including records of the payer 160 can be accessed as an integrated data source 170 by the system 200. Integrated data sources 170 can be any public or private electronic source or database holding a collection of verified patient identity information. These IDSs can include, but are not limited to, identifying data such as address, phone number, date of birth, drivers' license information, etc.

For example, system 200 may have access to information contained in an electronic healthcare record database of IDS 1. From this database, the system 200 can obtain information for a patient, including, but not limited to: given name; family name; middle name; state; city; zip code; gender; date of birth—day; date of birth—month; date of birth—year; and/or whether or not the user 110 is a minor. If used, the system 200 can additionally obtain from IDS1 physical characteristics of a patient 110 (i.e., height, weight, race, eye color), contained in the electronic healthcare record database. In one embodiment, collector client software, as described in co-pending U.S. patent application Ser. No. 14/668,307, previously incorporated herein by reference, is installed in the electronic medical record (EMR) system of each provider 130, or in a data center serving the provider 130 to obtain data from each patient record stored in a provider's EMR system and make the data available to the system 200. In accordance with HIPAA regulations, the system of the invention only collects and retains the pertinent information needed to achieve its mission. Personal Patient data is not released to any outside party.

The DMV or other state or governmental databank is another possible integrated data source 170 accessible by the system 200. From such a databank the system 200 can obtain information including, but not limited to: given name; family name; middle name; state; city; zip code; gender; date of birth—day; date of birth—month; date of birth—year; whether or not the user 110 is a minor; and/or, if desired, physical characteristics of a patient 110.

In one assisted check-in embodiment of the invention, the system 200 may additionally ask for a visual confirmation of the identity information of the user 110. More particularly, in one such embodiment, the system 200—through the assisted authorization application, will prompt the operator 120 (i.e., the check-in clerk or staff) to verify that a photograph 310 obtained from the state or federal database using the Official ID 300 matches the person standing before the clerk. In short, the clerk is to enter yes or no as to whether the picture displayed on the clerk's computer, obtained from a state or federal database or other integrated data source 210, is a picture of the person standing before the operator 120 and representing himself or herself as the user 110. The response of the operator 120 can be used as one more data point that is weighted and scored with the other data points by the system 200. It should be noted that the confidence level and importance multiplier assigned to this data point value can be very low, as a person's appearance can change significantly over time (i.e., weight, facial hair growth, etc.). In one further embodiment of the invention, the system 200 must be acknowledged by selecting “yes” or “now” before the system 200 will proceed with the calculation of a Confidence Determination, discussed below.

In one particular embodiment of the invention, the user photographs the official ID card 300 with a scanner or camera of a provider's computing device 124 or a user's mobile device 112. The image of the ID card can be used to create multiple data point values, including, but not limited to, information on the user's presence at a particular location at a particular time, and other information associated with the card 300. In one embodiment, the system 200 compares the photograph of the entire driver's license 300 to an image of the entire associated user's driver's license in an integrated data source 170 (in this case, the Department of Motor Vehicles or DMV in the state issuing the ID). If a match is validated, the system 200 obtains the user information from the data records associated with the license in the DMV database. Thus, in the above-discussed embodiment, the system 200 of the invention utilizes a state ID card 300 to gather data points. It does not merely compare a user photo 310 contained on a driver's license 300 with the user photo used to issue the license by the DMV.

As will be discussed more particularly below, the data collected from the patient and the integrated data sources can be scored, based on their availability.

Validation can then be performed by algorithmic matching of like data from all collection methods. For example, the information obtained from the patient and from all of the integrated sources can be compared, including, but not limited to: given name; family name; middle name; state; city; zip code; gender; date of birth—day; date of birth—month; date of birth—year; whether or not the user 110 is a minor; and/or eligibility.

Additionally, after the validation is performed, it can be scored, as will be discussed below. Once scored, the system 200 can calculate and report the validation results based on all available scores. The scoring step can additionally include the step of cross-referencing of the patient identity information collected from one or more sources (i.e., patient identity card, integrated data sources, etc.) with information stored in the insurance eligibility system and/or databases to determine the insurance eligibility of the user 110.

In one particular embodiment of the invention, only after the validation results are calculated and reported will a biometric of the user 110 be collected. Additionally, if desired, the collected biometric can be scored and/or validated against a biometric collected from a biometric database of an integrated data source 70. The validation of the biometric can be scored and a final calculation made based on all validation results. A determination of the likelihood of authorization is generated based on all validation results and reported to the provider and/or payer, as desired.

Scoring and Determination Flows: A process 400 for the scoring of different information referenced above will now be discussed in connection with FIGS. 1, 2 and 4.

More particularly, in a first step of the process 400, the system 200 collects eligibility and identity information from different sources 210, including, but not limited to, from the patient 110 and the integrated data sources 170. Step 410. The system 200 then assigns a “Confidence” level to each dataset collected, based on the method and context by which the data was obtained. For example, data obtained from the patient 110 is assigned a lower Confidence level than data obtained from an integrated data source 70 over which the patient 110 has no control. Step 420. Preferably, the Confidence level determination is calculated using a plurality of data points. In one particular embodiment of the invention, three or more data points are used to determine the validity of the patient information.

Based on the confidence level assigned to the dataset in step 420, the system 200 assigns a multiplier that corresponds to each data point that is part of the dataset. The “Importance” level is pre-configured in the system 200 for each “field” of data (i.e., data point type—e.g. last name; first name; age; etc.) and each Confidence level. Step 430. Each data point is then scored by comparison across sources. Step 440. The score is calculated by multiplying a constant base value “v” with the Importance multiplier obtained in step 430 of the process 400. The base value “v” can be greater than zero or it can be less than zero. Where applicable, comparison algorithms, such as Soundex, Regex and/or Metaphone, can be used to determine a comparison match for data points.

The scores for all data points are then added together to obtain an overall score for the transaction. Step 450. The added up score is then compared to a predefined threshold amount. Step 460. If the score is greater than or equal to the threshold, a positive determination will be generated. Step 470. Otherwise, a score less than the threshold value results in a negative determination being generated. Step 480. The determination made is then reported to the provider and/or payer, as desired. Step 490.

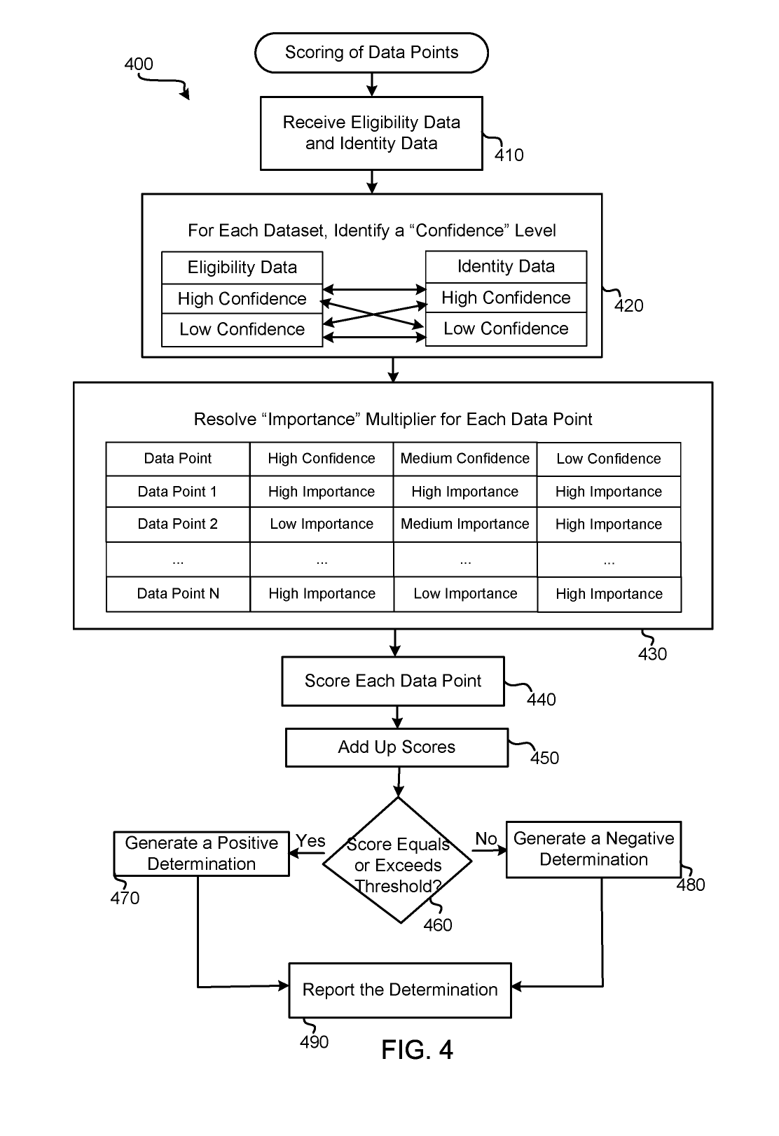

The Data Point Scoring Process: Referring now to FIGS. 1, 2, 4 and 5, there will now be described one embodiment of a data point scoring process 500 that can be used as the data point scoring step 440 of FIG. 4. First, it is determined if a value is present for a particular data point field (or just “data point”, as used herein) in at least one source. Step 510. If no data point value is available for a given data point field (for example, no last name value associated with the “last name” data point field in a source 210), that particular data point is assigned a negative base score. Step 520. If at least one value is available for the data point, the system 200 checks whether multiple data point values are available for a particular data point field (i.e., over multiple sources 210). Step 530. If the value for a particular data point is available from one source, but not across multiple sources, then the data point is assigned a positive base (Step 540) and an “Importance” multiplier is applied (Step 550). If a value for a particular data point if available from multiple sources, those values are collected and compared with one another. Step 560. If they match (step 570), then a positive base score is assigned to the data point (step 540), otherwise, a negative base score is assigned to the data point (step 520). An Importance multiplier is then applied to the resulting base score for each data point (step 550), and the resulting data point score (i.e., the base score times the Importance multiplier) is provided to the system 200 (step 580), which adds the scores for all data points to obtain an overall score for the transaction, as discussed above in connection with step 450 of FIG. 4.

Scoring: At the time of setting up the system 200, an implementer (e.g., system administrator 150, payer 160, etc.) can assign scores to different pieces of information that can be used to issue a determination. A score for a given data point will have multiple values depending on that data point's overall importance to the process (“Importance”) and how confident the implementer is with the method in which the information was obtained (“Confidence”).

Confidence: Each dataset can be collected through one or more different methods, each with its own degree of reliability (in the context of this process). Since it is possible to have more than one method of collection, the implementer needs to identify the potential sources for the different datasets and, for each potential source identified, assign a level of confidence for the dataset. For example, referring now to FIGS. 1-3B and 6, the assignment of confidence levels to a dataset will be described using the exemplary chart 600.

As discussed above, there are multiple ways in which a dataset can be entered into the system. For purposes of example, those methods include, but are not limited to: “swiping” of an officially issued ID card 300 (i.e., electronically reading the magnetic stripe 320 on the back of the ID card with a magnetic card reader); scanning a barcode 330, 340 on an ID card 300 or paper record; and/or manually entering data by, or provided by, the patient 110. For each entry method, the system 200 of FIG. 2 assigns a confidence level to the dataset as a whole.

For example, in the present particular embodiment, the user 110 is asked to produce a recognized officially issued state or federal identification card 300 or other officially issued ID card, such as a driver's license, state ID or federal government ID. In the most preferred embodiment, the provided officially issued ID card 300 can be read electronically, since the electronic reading of the ID card provides conclusive proof that the Official ID was present at the visit, thus the system may assign a high confidence level to the dataset electronically read from the ID card 300. Electronic reading of an ID or insurance card includes, but is not limited to, electronically reading information stored on the card via a magnetic strip reader, smartcard reader, passive near-field electronic ID reader, OCR or another type of electronic reader, with each type of entry method being assigned its own confidence level in the system 200.

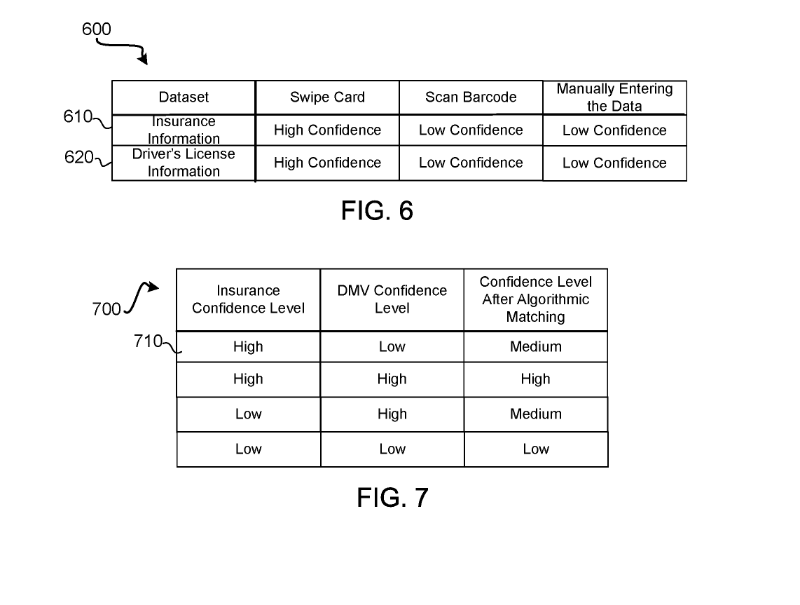

In the example illustrated in FIG. 6, for a dataset 610—“Insurance Information” of a patient, the system has been configured, in software, to assign a high level of confidence to the dataset if its entry was the result swiping an insurance card to automatically electronically enter the data into the system; a low level of confidence if a barcode of the user ID or records is scanned; and a low level of confidence if the insurance information is manually entered. Similarly, for the dataset 620—“Driver's License Information”, the system has been configured, in software, to assign a high level of confidence to the dataset if its entry was the result swiping the user's Officially issued State ID—the driver's license in this example—to automatically electronically enter the data into the system; a low level of confidence if a barcode of the user ID is scanned; and a low level of confidence if the insurance information is manually entered.

Thus, when performing algorithmic matching of each individual data point (step 570 of FIG. 5) the confidence levels assigned to each data point (while part of their datasets) are combined to yield a resulting confidence level that applies to all resulting data points. For example, if the driver's license information was obtained via manual input (low confidence) and the insurance information was obtained electronically by swiping the card (high confidence), the result of the comparison of any data point shared by the two datasets would have a medium confidence level. See, for example, table 700 of FIG. 7, illustrating all confidence level combinations possible for information items (i.e., data points) common to both the Insurance Information dataset and the Driver's License dataset, depending on each dataset's assigned confidence level (low or high). In one particular example, illustrated using row 710 of table 700, when scoring a data point, such as “Last Name”, the process matches the “Last Name” value from an Insurance Information dataset having high confidence and the “Last Name” value from a Driver's License dataset having low confidence, which results in the data point value for “Last Name” being scored with a medium confidence level.

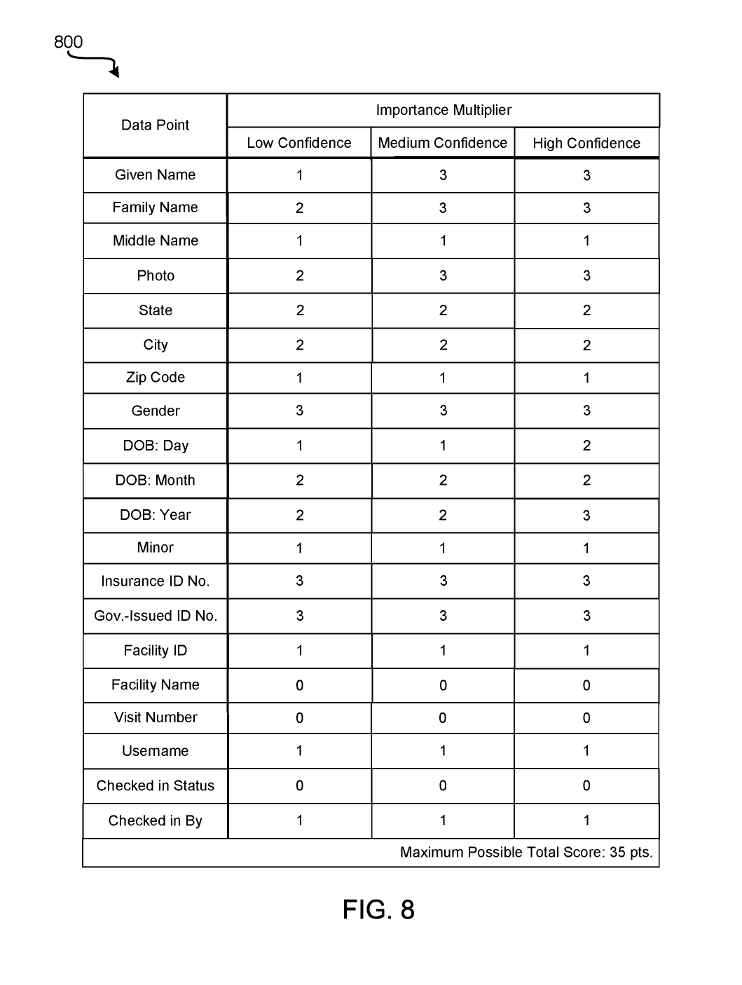

Assigning Importance to the Data Points: Referring now to FIGS. 1, 2 and 8, the system 200 relies on a set of data points to issue a determination. Those data points have a specific impact in the calculation of the determination, as defined by the implementer of the process (System Administrator, Payer, Provider, etc.). That impact is expressed in terms of an “Importance Multiplier” that can be different for each given data point, depending on the level of confidence assigned to the method used to obtain it. FIG. 8 illustrates one particular example of how the Importance Multiplier can be assigned to the data points. In the example given in table 800, a value of zero (“0”) is assigned to a data point that, while collected by the system, is not used for scoring and determination purposes. Note that the invention is not intended to be limited to the Importance Multipliers provided in table 800. Rather, the values in table 800 are provided as examples of how the implementer may assign the Importance Multipliers for each data point and each confidence level.

During the scoring process (step 440 of FIG. 4 and step 550 of FIG. 5), the system (200 of FIG. 2) will retrieve the Importance Multiplier value that matches the confidence level for a particular data point. Using the previous example, the data point “Last Name”, having a medium confidence level (derived from the combination of two sources, one having a high level and one having a low level) will be scored using an Importance Multiplier of “3”, according to table 800.

Determining the Threshold: In step 460 of FIG. 4, the system 200 compares the total resulting from the sum of the individual data point scores (step 450 of FIG. 4) to a pre-determined threshold (step 460 of FIG. 4). In one particular embodiment of the invention, an implementer defines this threshold in terms of a percentage of the total possible score according to the following formula:

Threshold=Maxscore×(Percentage value/100)

In the example of FIG. 8, the maximum possible total score for that exemplary set of data points is 35. If the implementer has set the threshold to 80%, then the total score needs to be equal to or greater than 28 points in order to get a positive determination (i.e., 35×(80/100)=28).

Exemplary Authorization Processes: Referring now to FIGS. 1-9, there is shown an exemplary authorization process 900, useful in understanding one particular embodiment of the present invention. The diagram 900 is one example of how a process can be built around the authorization algorithm 220 in order to collect, process and validate user/patient data to obtain authorization for a patient's access to health care services and/or goods.

Registration: In the present embodiment of the invention, a registration process is performed for users/patients 110 of the system, the first time that the user 110 requests access to, or authorization by, the system 100. The method 900 can be used to register the first time user 110 either in a desktop-based environment or in connection with a portable mobile application of the user 110, and in either an assisted setting, or unassisted.

First, the user 110 requests access to the system 200. Step 910. The user 110 will enter his or her account information required by the system (i.e., account number, policy number, user id, etc). Step 912. The system 200 will check that the entered account number is valid in the system. Step 914. This acts as a gatekeeper for accessing the system 200. Users 110 without valid account information will not be able to proceed. Step 916.

ID Capture: In one particular embodiment, the system 200 can capture the user's information without asking the user 110 to enter it manually. If there is a camera available (step 918), an image of the user's ID card (300) or other identification document is captured by taking a picture of the front side and, if applicable, the back side of the ID card or materials. Step 920. Optionally, pictures taken from the ID card 300 or other materials can also be kept as an additional point of comparison for later use. In the absence of a camera, the user ID can be checked by manually entering the number, or by scanning, or swiping the ID or other material with an available peripheral. Step 926.

Additional Data Collection: In an assisted registration process, if a camera is available, the system 200 will guide the operator 120 to take a picture of the face of the patient 110 using an internal or attached camera of the computing device 124. Step 922. If this is an unassisted registration process, the user/patient 110 will take a “selfie”. The system 200 will not allow the use of existing pictures. The picture needs to be taken at that time.

Once the ID of the user 110 has been captured, the Issuer (such as the DHSMV, INS, Military, etc.) is contacted and information associated with the user 110 is retrieved. Step 924. By connecting to the ID and the Account Eligibility databases, the system 200 will retrieve a data set including multiple data points from both sources for further comparison.

All the data collected is passed along to the Authorization and Determination Algorithm 220 for scoring. Step 928. In one particularly preferred embodiment, scoring can be performed as discussed in connection with FIGS. 4 and 5. Alternately, other scoring methods can be used. The algorithm 220 will return an overall score for the transaction. Step 928.

If the score meets or exceeds a predefined threshold (step 930), the system 200 concludes that there is a positive match and the first time user 110 is authorized for access to goods and/or services. Once the authorization of the patient 110 has been established, the system 200 can capture additional data points that can be used for quick authorization later. For example, at this stage, and only after the entitlement of the user 110 has been fully authorized, as discussed herein above, the system 200 can instruct the operator 120 or patient 110 to capture one or more biometrics of the patient (step 942) along with an identifier for the device being used for registration (step 944). The user 110 is registered with the system 200 and all the required information including, if provided, a biometric, is stored in, for example, a database 156 associated with a server 154 of the system operator and/or in a non-transitory memory of a computing device (mobile or otherwise) of the provider 130 and/or a mobile device 112 of the user 110. Step 946. The stored information can be used to speed up future validation requests. More particularly, in the present embodiment, after the algorithm 240 determines that the threshold has been met, the patient's provided ID materials can be stored and an associated biometric can be used to quickly recall the information in the future.

The biometric can be captured by a biometric device, which can include, but is not limited to, one or more of a palm vein reader, a fingerprint scanner or reader, an iris scanner, a facial recognition system. In one particular exemplary embodiment, a palm vein reader, such as the PalmSecure™ by Fujitsu® is used as the primary biometric input device. The Fujitsu® PalmSecure™ authenticates users based on vein pattern recognition, rather than iris scanner or fingerprint readers. Veins are internal and have a wealth of differentiating features. Thus attempts to forge an indentify are extremely difficult, thereby enabling a high level of security. Such a reader features good authentication accuracy, while being non-intrusive and contactless—thus providing ease of use with virtually no physiological restrictions for all users.

Additionally, and most importantly to the present invention, the user 110 is authorized for service (step 948), and the provider's staff and/or operator are notified of the successful determination (step 950). Such notification can be provided from the system 200 to a computing device 124 of the provider 130, for example, via a display of the check-in computer 124 being operated locally by the operator 120, or via the user's mobile device 112.

If the scoring algorithm in step 930 does not yield a value that exceeds the threshold, the process can rely on a support representative 140 to do a comparison of the captured information. The user 110 will be given the opportunity to communicate with a representative 140 who has access to the captured information. If the representative 140 considers that there is a valid match, the system 200 will conclude that this is an authorized transaction and will continue with the registration process at step 942. If the representative 140 is unable to confirm the identity of the user 110, the user 110 will not be registered, and authorization will not be given for goods and/or services. Step 940.

In one particular embodiment, the system 200 provides a display, notification and/or report to the provider 130 of ‘service authorized’, ‘service not authorized’ or ‘transaction subject to audit’, based on the determination made by the system 200.

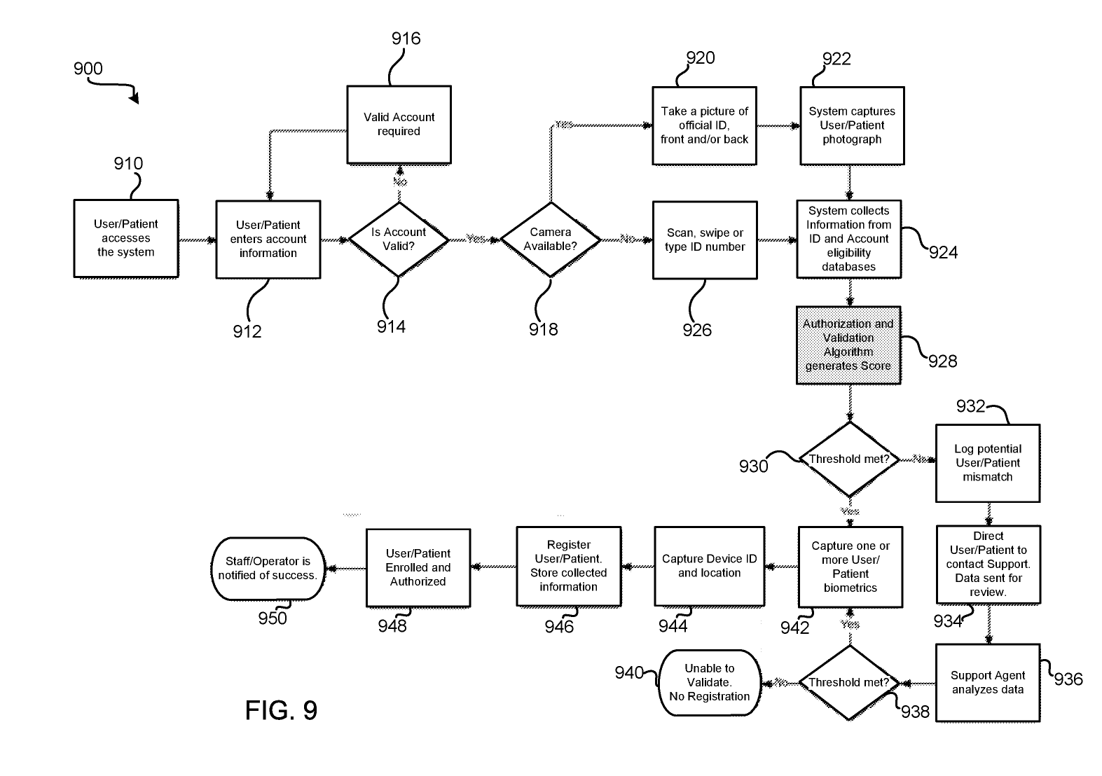

Note that the invention is not intended to be limited only to the process illustrated In FIG. 9. Rather, the system 200 and/or process 900 can be modified to deal with more specific requirements and/or expanded sets of data points without departing from the scope or spirit of the present invention.

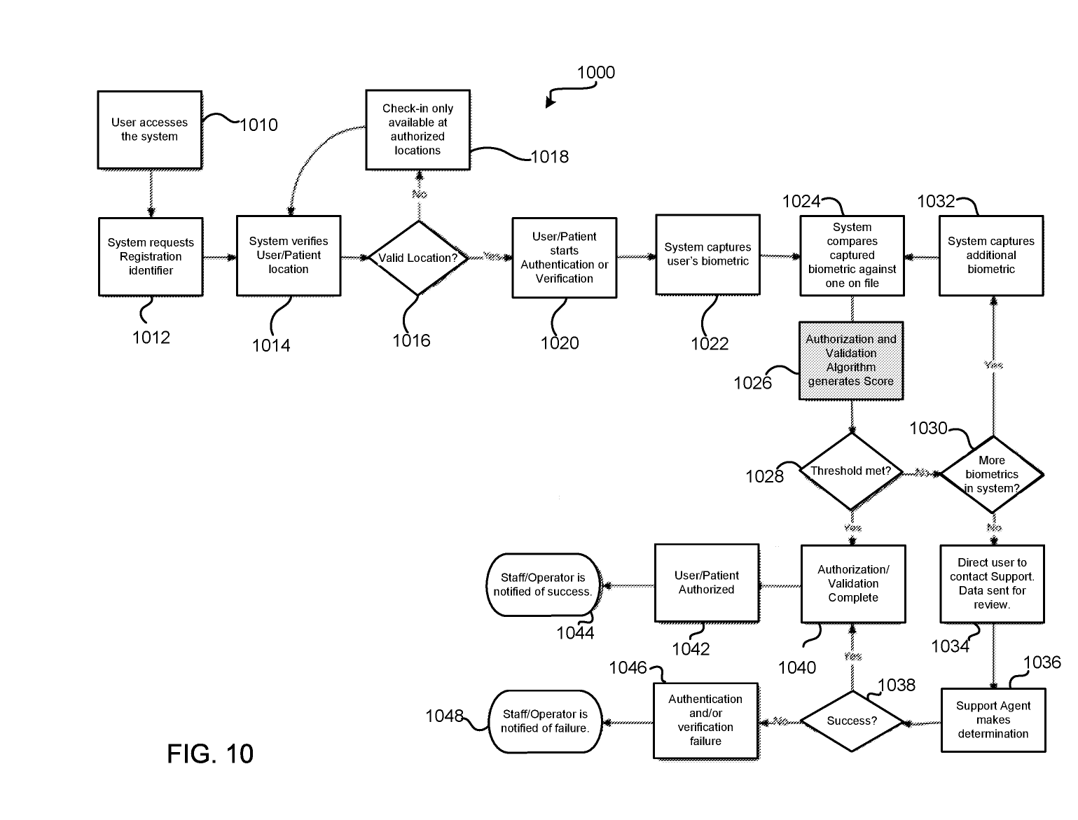

Registered User Authorization and Validation: Referring now to FIGS. 1-10, there will be described a registration process 1000 engaged in by returning users or patients 110 that have already used the system before, and thus, have been previously properly enrolled by a process, such as the process 900 of FIG. 9. The process 1000 is representative of a returning authorization process that can be used on a portable mobile device 112 of the user 110, or on a computing device 124 of the provider 130, either assisted or unassisted. Additionally, the process 1000 can be modified to deal with more specific requirements or expanded sets of data points, as desired.

In one preferred embodiment of the method 1000, a user or patient 110 will seek access to the system 200, either unassisted (typically via the mobile device 112) or with the help of an operator 120. Upon initiating the contact, the system 200 will require an account number or other identifier (i.e. account number, policy number, user id, etc.) that links the user 110 to an existing registration in the system 200. This could be the same account number provided during registration in process 900. Step 1010.

The system 200 will capture the location of the device 112, 124 from which the access is requested. Step 1014. This would be the point-of-service (POS) location of the desktop system 124 in assisted scenarios (e.g., the location of the provider 130), or the location of the portable device 112 in mobile scenarios. The system 200 assesses validity of the location by comparing against known POS installations, or previously authorized mobile devices 112. Step 1016. The system will not allow transactions to come from unknown/unauthorized devices and/or locations. Step 1018.

Once the access location has been successfully validated, the user 110 will be directed to start the authentication and verification process. Step 1020. The system 200 will guide the user 110 to capture a biometric. Step 1022. Then, the Authorization and Validation algorithm 220 processes the captured customer information, which includes comparing the captured biometric with the one on file. Step 1024. Once matched, the ID information previously stored in step 946 is analyzed as discussed in connection with FIGS. 4 and 5, herein. As discussed above, the algorithm 220 will yield an overall score for the transaction. Step 1026. If the score meets or exceeds a pre-defined threshold, the system 200 concludes that there is a positive match. Step 1028.

If there is no match but there are additional biometrics on file, the system 200 will request a different biometric and pass it along to the algorithm 220. Step 1030. This can be repeated for as many biometrics as the system has stored for the user 110, until the resulting score adds up to more than the pre-defined threshold. Step 1040.

Once biometric analysis is satisfactory, the Authorization and Validation algorithm 220 returns a positive determination authorizing the user 110. Step 1042. This determination is passed along to the Operator or staff 120, to let them know that the user 110 has been authorized. Step 1044. In one embodiment of a self-conducted scenario, the system 200 notifies the user 110 of the successful authorization.

If after one or more biometric comparisons in step 1030 the algorithm still does not yield a score that exceeds the threshold, the system 200 will direct the user 110 or operator 120 to contact a support representative 140 to validate the user 110. Step 1034. The support representative 140 will have access to all or a subset of the information captured in the process 900. If the support representative 140 determines in step 1036 that the user 110 is a valid match, the authorization and validation process will continue at step 1040.

If the support representative denies authorization and validation in step 1036, the user will not be successfully authorized or validated. Step 1046. The event will be logged, and the system can, optionally, notify the user 110, operator/staff 120, provider 130 and/or payer 160 of the authorization failure. Step 1048.

An inability to validate a user 110 using the methods 900 and/or 1000 can be an indicator or prediction rendered by the system 200 of a likelihood of fraud. The provider 130 is free to determine how they want to use the information when providing services to the user 110. However, the system 200 can be used to generate reports that are available to a payer, as well. For example, the provider 130 may receive a notification that a user 110 has failed to be authorized for services and/or goods (step 1048), but the provider 130 may still choose to, or be obligated by law to, provide services to the user 110. A payer 160 can then access a report detailing the determination of the system 200 and services provided by the provider 130, to decide whether or not the provider 130 is to be reimbursed for the services/goods provided to the non-authorized user 110. In one particular embodiment of the invention, the confidence level determination can be used to inform the payer whether the provider's treatment of the user 110 is ‘payable’, ‘not payable’ or ‘subject to audit’.

In particular, a payer (who may be an insurer or governmental provider) can review minute by minute information, and/or can receive information summaries monthly, quarterly, etc. Reports can be generated that identify significant statistical outliers and point out fraudulent activities, to stay ahead of ever changing fraudulent schemes. Additionally, particular provider billings can be sampled against all of the data captured by the system 200 (including every provider 130 and/or beneficiary in the system) to learn and identify patterns of fraud in order to alert the payer.

The information provided by the systems of the present invention allows providers to ensure that they are treating the right person and that the person is eligible for benefits. Thus, validation takes place at the point-of-service (i.e., the facility check-in) and at every provider location 130 in the health care system (i.e., hospitals, doctors' offices, pharmacies, laboratories, diagnosticians, etc.). Additionally, in one particular embodiment of the invention, a record of the interaction can be stored to prove the presence of the patient 110 at a particular location at a particular day and time, in order to reduce the occurrence of phantom billing practices. For example, by collecting basic information about the check-in process (e.g., official ID cards/insurance cards typically not read for patients 110 of a particular physician; etc.,), the system can verify whether or not a patient 110 was present for a visit. By collecting details relating to patient presence verifications (i.e., for a particular provider or practice 130), payers 160 can easily highlight potential phantom billers.

As discussed herein above, the authorization determination made by the system 200 can be used to indicate a confidence level regarding the probability of fraud being committed by a presenting patient 110. The final decision on patient care is left to the physician/provider 130. The system of the present invention does not, itself, prevent or deny medical services to patients 110.

After the patient 110 receives treatment/goods at the provider location, the information is stored in an electronic record (i.e., an EMRS), as is typical. However, either periodically (batch) or in real-time (downstreaming), the EMRS provides the stored clinical treatment information to the system 200, for storage in at least one database or data store 156, in association with the patient 110 and can be used as data points in future transactions with the patient 110.

To summarize one particular embodiment of the invention, a services and payment authorization system is provided to prevent the rendering of services and reimbursement for fraudulent healthcare transactions resulting from identity theft, phantom billing and medical fraud, in general. Identity information of a user 110, wishing to receive goods or services as part of a healthcare transaction is collected by the system 200, via a front-end software application interface at the provider location, or on a mobile device of the user. Optionally, an operator 120 can make a visual confirmation of the identity information provided by the user 110. The system 200 pulls data point values from one or more sources, and more preferably, from multiple sources. The collected data point values are scored through a process using confidence levels and Importance Multipliers assigned to the data point values. In one embodiment, confidence levels are assigned to the datasets based on how the datasets were obtained by the system 200. Additionally, Importance Multipliers (assigned in the system 200) are applied to the data point values. The system 200 uses these values to make a programmatic calculation of a Confidence Determination, which can be provided to providers 130 to determine whether to provide goods and/or services to the user 110. Similarly, the Confidence Determination can be provided payers 160, via a software interface, to determine whether or not to reimburse the providers 130 for goods and/or services provided. It can be seen that the confidence level determination discussed herein can be optimized through the analysis of historical records and newly collected patient information.

In one particular embodiment of the invention, only after a Confidence Determination has been made indicating that the user is entitled to receive healthcare goods and/or services, is a biometric of the patient 110 captured. This biometric is used to accelerate transaction initiation (i.e., to recall stored authorization data of a user 110) and not to authorize the client, by itself.

In accordance with the foregoing, it can be seen that the present invention utilizes an adaptive algorithm that can provide, in real-time, an indication regarding a level of probability that a health care transaction is fraudulent. This information can be provided to a government agency or other payer to evaluate and cross check a claim before funds are disbursed. This eliminates the “pay and chase” methodology in place today throughout the government, without introducing any impediment to Patient care. Additionally, the system of the present invention can be used to detect and prevent both beneficiary-fraud (i.e., identity theft, Patient involved fraud, drug seeking behavior, doctor-shopping, pharmacy-shopping) and Provider-fraud (i.e., phantom billing and medical equipment delivery fraud, etc.) prior to disbursement of significant funds.

The systems of the present invention also deliver a powerful “observer effect”, as fraudulent Providers of all types and beneficiaries understand that the health care process is being watched. The consequence is similar to the reduction in crime in a geographical area resulting from an increased, visible police presence.

The present invention provides medical data collection and fraud prediction system and method as described herein. Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

We claim:

1. A system for authorizing a user to receive at least one of healthcare related goods or services, comprising:
a computing device configured to make an authorization determination regarding the eligibility of the user for goods or services, a processor of said computing device configured by authorization and determination software to:
obtain at least one non-biometric identity information dataset of the user from a first source;
assign a confidence level to the at least one identity information dataset;
assign an importance multiplier to each data point of the at least one identity information dataset;
score each data point using the confidence level of the dataset of which the data point is part and the importance multiplier assigned to the data point;
add together the scores for each data point to obtain an overall score and comparing the overall score to a preset threshold; and
if the overall score is greater than or equal to the preset threshold, report that the user is authorized to receive at least one of healthcare goods or services, otherwise, if the overall score is less than the preset threshold, report that the user is not authorized to receive the at least one of healthcare goods or services.

2. The system of claim 1, wherein the first source includes a computing device providing data to said authorization and determination software over a communications network.

3. The system of claim 2, wherein the first source is a computing device disposed at a location associated with a provider of healthcare goods or services.

4. The system of claim 2, wherein the first source is a mobile computing device of the user executing a software application to obtain an identity information dataset from the user.

5. The method of claim 1, further comprising a biometric reader operatively connected to collect a biometric of the user after the authorization and determination software determines that the user is authorized.

6. The system of claim 1, wherein the authorization and determination software is additionally configured to:
receive eligibility data for the user based on identity information of the user; and
cross-reference data point values of the first identity information dataset against the eligibility data when scoring the data point values.

7. The system of claim 10, wherein a second identity information dataset is obtained from a second source different from the first source, and the authorization and determination software compares at least one data point value from the first identity information dataset with a data point value from the second identity information dataset for the same data point field when scoring the data point values.

8. The system of claim 7, wherein the second source is an integrated data source accessible by said computing device.

9. The system of claim 8, wherein said second source is an eligibility database of a payer accessible via a communications network.

10. A method for authorizing a user to receive at least one of healthcare related goods or services, comprising the steps of:
obtaining a first identity information dataset of the user from a first source in a healthcare authorization system;
assigning a confidence level to the first identity information dataset by a processor of a computing device configured by software to assign the confidence level;
assigning an importance multiplier for each data point of the first identity information dataset by the processor based on importance levels pre-configured in the system;
scoring each data point using the confidence level of the dataset of which the data point is part and the importance multiplier assigned to the data point;
adding together the scores for each data point to obtain an overall score and comparing the overall score to a preset threshold; and
if the overall score is greater than or equal to the preset threshold, reporting that the user is authorized to receive at least one of healthcare goods or services, otherwise, if the overall score is less than the preset threshold, reporting that the user is not authorized to receive the at least one of healthcare goods or services.

11. The method of claim 10, wherein the processor is configured to assign the confidence level to a dataset based on at least one of the method or context by which the data was obtained.

12. The method of claim 10, wherein the importance multiplier is pre-configured in the system for at least one of each particular data point field or a confidence level assigned to the data point.

13. The method of claim 10, further comprising the step of collecting a biometric of the user using a biometric reader only after it is reported that a user is authorized in the reporting step.

14. The method of claim 10, further comprising the steps of:
receiving eligibility data for the user based on identity information of the user; and
cross-referencing data point values of the first identity information dataset against the eligibility data in the scoring step.

15. The method of claim 10, wherein a second identity information dataset is obtained from a second source different from the first source, and at least one data point value from the first identity information dataset is compared with a data point value from the second identity information dataset for the same data point field in the scoring step.

16. The method of claim 15, wherein a positive base score is assigned to the data point if the comparison results in a match.

17. The method of claim 10, wherein a dataset entered manually into a computing device of the first source is assigned a lower confidence level than a dataset obtained electronically from an electronic data reader or an integrated data source over a communications network.

18. A non-transitory computer readable medium with instructions stored thereon, that when executed by a processor, perform the steps comprising:
obtaining a first identity information dataset of a user from a first source;
assigning a confidence level to the first identity information dataset;
assigning an importance multiplier for each data point field of the first identity information dataset;
scoring each data point field using the confidence level of the dataset of which the data point is part and the importance multiplier assigned to the data point;
adding together the scores for all data point fields to obtain an overall score and comparing the overall score to a preset threshold; and
if the overall score is greater than or equal to the preset threshold, reporting that the user is authorized to receive at least one of healthcare goods or services, otherwise, if the overall score is less than the preset threshold, reporting that the user is not authorized to receive the at least one of healthcare goods or services.

19. The computer readable medium of claim 18, wherein the instructions stored thereon, when executed by a processor, further perform the steps comprising:
receiving eligibility data for the user based on identity information of the user; and
cross-referencing data point values of the first identity information dataset against the eligibility data in the scoring step.

20. The computer readable medium of claim 18, wherein a second identity information dataset is obtained from a second source different from the first source, and at least one data point value from the first identity information dataset is compared with a data point value from the second identity information dataset for the same data point field in the scoring step.
